(19) United States
(12) Patent Application Publication
(10) Pub. No.: US 2011/0147641 A1
(43) Pub. Date: Jun. 23, 2011

(54) SURFACE-MODIFIED SUPERPARAMAGNETIC OXIDIC PARTICLES

(75) Inventors: Juergen Meyer, Stockstadt (DE); Markus Pridoehl, Grosskrotzenburg (DE); Guido Zimmermann, Bruehl (DE); Michael Kroell, Linsengericht (DE); Stipan Katusic, Bad Soden (DE)

(73) Assignee: Evonik Degussa GMBH, Essen (DE)

(21) Appl. No.: 12/922,808

(22) PCT Filed: Mar. 30, 2009
(86) PCT No.: PCT/EP2009/053738

§ 371 Date: Oct. 22, 2010

(30) Foreign Application Priority Data
Apr. 28, 2008 (DE) 10 2008 001 437.0

(51) Int. Cl. H01F 1/00; B05D 5/12

(52) U.S. Cl. 252/62.51 R; 427/127

(57) ABSTRACT

Surface-modified superparamagnetic oxidic particles, characterized by the following physicochemical characteristics: BET surface area 20 to 75 m2/g; Carbon content 0.5 to 6.0% by weight; Tamped density 150 to 500 g/l; Chlorine content 50 to 1000 ppm; Drying loss 0.1 to 4.0% by weight are prepared by contacting the oxides with the surface modifier either by spraying or vapour deposition and then heat-treating them. The surface-modified oxidic particles can be used as a filler in adhesives. Further fields of application are use for data carriers, as a contrast agent in imaging processes, for biochemical separation and analysis processes, for medical applications, as an abrasive, as a catalyst or as a catalyst support, as a thickener, for thermal insulation, as a dispersing assistant, as a flow assistant and in ferrofluids.

The invention relates to surface-modified superparamagnetic oxidic particles, to a process for preparing them and to the use thereof.

Superparamagnetic oxidic particles are known from EP 1 284 485.

The invention provides surface-modified superparamagnetic oxidic particles, characterized in that they have the following physicochemical characteristics:

| | |
|---|---|
| BET surface area | 20 to 75 m²/g |
| Carbon content | 0.5 to 6.0% by weight |
| Tamped density | 150 to 500 g/l |
| Chlorine content | 50 to 1000 ppm |
| Drying loss | 0.1 to 4.0% by weight |

The invention further provides a process for preparing the surface-modified superparamagnetic oxidic particles, characterized in that the oxidic particles are optionally first sprayed with water and then with the surface modifier at room temperature, optionally mixed for 15 to 30 minutes and finally heat-treated at 50 to 400° C. for 1 to 6 h.

The water used can be acidified with an acid, for example with hydrochloric acid, down to a pH of 7 to 1.

Alternatively, the surface modification of the oxidic particles can be carried out by treating the oxidic particles with the surface modifier in vapour form and then thermally treating the mixture at a temperature of 50 to 800° C. over a period of 0.5 to 6 h. The thermal treatment can be effected under protective gas, for example nitrogen.

The surface modification can be carried out in heatable mixers and dryers with spray devices, continuously or batchwise. Suitable apparatus may, for example, be: ploughshare mixers, pan dryers, fluidized bed dryers or moving bed dryers.

The superparamagnetic oxidic particles used may be oxidic particles as described in EP 1 284 485.

In particular, it is possible to use pyrogenic oxidic particles which contain superparamagnetic metal oxide domains with a diameter of 3 to 20 nm in a nonmagnetic matrix comprising metal oxides or metalloid oxides, with a chlorine content of 50 to 1000 ppm.

The chloride content originates from the preparation of the particles. The particles usable in accordance with the invention are obtained by a pyrogenic process in which chlorine-containing precursors are reacted, for example, in a hydrogen/oxygen flame. The particles which form may comprise chlorine, for example, in the form of oxychlorides from incomplete flame oxidation and in the form of hydrochloric acid. When these compounds are incorporated into the particles which form, the chloride content of the particles cannot be reduced further even by purification steps without destroying the particles.

The chloride content of the particles usable in accordance with the invention may be up to not more than 1000 ppm. Purification steps can preferably provide particles with a chloride content of 100 to 500 ppm. It can be reduced to values down to 50 ppm by further purification steps.

The total chloride content is determined by Wickbold combustion or by digestion with subsequent titration or ion chromatography.

The preparation of superparamagnetic particles which contain chloride in a pyrogenic process is surprising because, among others, Barth et al. (Journal of Material Science 32 (1997) 1083-1092) state that chloride ions have a directing effect for the formation of the nonsuperparamagnetic beta-iron oxide (β-Fe₂O₃) from iron(III) chloride. Gonzáles-Carreño et al. (Materials Letter 18 (1993) 151-155) were also of the opinion that no superparamagnetic particles are obtained in the spray pyrolysis of iron(III) chloride, in contrast to other precursors.

The particles usable in accordance with the invention may have different states of matter depending on the regime of the pyrogenic process. Influencing parameters may be residence time, temperature, pressure, the partial pressure of the compounds used, the type and the location of cooling after the reaction. Thus, a wide spectrum from very substantially spherical to very substantially aggregated particles can be obtained.

The domains of the particles usable in accordance with the invention are understood to mean spatially separated superparamagnetic regions. As a result of the pyrogenic process, the particles usable in accordance with the invention are very substantially pore-free and have free hydroxyl groups on the surface. They have superparamagnetic properties when an external magnetic field is applied. However, they are not permanently magnetized and have only a low residual magnetization.

In a particular embodiment, the carbon content of the particles usable in accordance with the invention may be 0.5 to 6.0% by weight.

The BET surface area, determined to DIN 66131, of the inventive particles can be varied over a wide range from 10 to 600 m²/g. The range is particularly advantageously between 20 and 75 m²/g.

The tamped density, determined to DIN ISO 787/11, of the inventive particles can be varied over a wide range of 150 to 500 g/l. The range is particularly advantageously between 200 and 350 g/l.

The drying loss (2 hours at 105° C.), determined to DIN ISO 787/11, of the inventive particles can be varied over a wide range from 0.1 to 4.0% by weight. The range is particularly advantageously between 0.5 and 2.0% by weight.

In a preferred embodiment, the “blocking temperature”, the temperature below which no superparamagnetic behaviour can be detected any longer, of the particles usable in accordance with the invention cannot be more than 150 K. As well as the composition of the particle, this temperature may also depend on the size of the superparamagnetic domains and the anisotropy thereof.

The proportion of the superparamagnetic domains of the particles usable in accordance with the invention may be between 1 and 99.6% by weight. Within this range, as a result of the nonmagnetic matrix, spatially separated regions of superparamagnetic domains are present. The region with a proportion of superparamagnetic domains is preferably greater than 30% by weight, more preferably greater than 50% by weight. The achievable magnetic action of the particles usable in accordance with the invention also increases with the proportion of the superparamagnetic regions.

The superparamagnetic domains may preferably comprise the oxides of Fe, Cr, Eu, Y, Sm or Gd. In these domains, the metal oxides may be present in a homogeneous polymorph or in different polymorphs.

In addition, it is also possible for regions of nonmagnetic polymorphs to be present in the particles. These may be mixed oxides of the nonmagnetic matrix with the domains. One example thereof is iron silicalite (FeSiO₄). These nonmagnetic constituents behave towards the superparamagnetism like the nonmagnetic matrix. In other words: The particles are superparamagnetic, but the saturation magnetization falls with increasing proportion of the nonmagnetic constituents.

In addition, it is also possible for magnetic domains to be present, which, owing to their size, do not exhibit superparamagnetism and induce remanent magnetization. This leads to an increase in the volume-specific saturation magnetization. According to the field of use, it is possible to produce particles adapted in this way.

A particularly preferred superparamagnetic domain is iron oxide in the form of gamma-Fe₂O₃ (γ-Fe₂O₃), Fe₃O₄, mixtures of gamma-Fe₂O₃ (γ-Fe₂O₃) and Fe₃O₄ and/or mixtures of the above with iron-containing, nonmagnetic compounds.

The nonmagnetic matrix may comprise the oxides of the metals and metalloids of Si, Al, Ti, Ce, Mg, Zn, B, Zr or Ge. Particular preference is given to silicon dioxide, aluminium oxide, titanium dioxide and cerium oxide. In addition to the spatial separation of the superparamagnetic domains, the matrix also has the task of stabilizing the oxidation state of the domains. For example, magnetite as the superparamagnetic iron oxide phase is stabilized by a silicon dioxide matrix.

The particles usable in accordance with the invention can be modified by adsorption, reactions at the surface or complexation of or with inorganic and organic reagents.

The particles usable in accordance with the invention may also be coated partially or completely with a further metal oxide. This can be done, for example, by dispersing the particles usable in accordance with the invention in a solution comprising organometallic compounds. After the addition of a hydrolysis catalyst, the organometallic compound is converted to its oxide, which is deposited on the particles usable in accordance with the invention. Examples of such organometallic compounds are the alkoxides of silicon (Si(OR)₄), of aluminium (Al(OR)₃) or of titanium (Ti(OR)₄).

The surface of the particles usable in accordance with the invention can also be modified by adsorption of bioorganic materials, such as nucleic acids or polysaccharides. The modification can be effected in a dispersion comprising the bioorganic material and the particles usable in accordance with the invention.

The invention further provides a process for preparing the particles usable in accordance with the invention, which is characterized in that a compound comprising the metal component of the superparamagnetic domains, and a compound comprising the metal or metalloid component of the nonmagnetic matrix, at least one compound being chlorine-containing, are evaporated, the amounts of vapour corresponding to the ultimately desired ratio of the superparamagnetic domains and nonmagnetic matrix together with a carrier gas are mixed in a mixing unit with air and/or oxygen and combustion gas, the mixture is fed to a burner of known design and reacted in a flame within a combustion chamber, then the hot gases and the solids are cooled, then the gases are removed from the solids and the product is optionally purified by a thermal treatment by means of gases moistened with steam.

The combustion gases used may preferably be hydrogen or methane.

The particles usable in accordance with the invention may also be obtained by a process in which an aerosol is fed into a gas mixture of a flame hydrolysis or flame oxidation, comprising the precursor of the nonmagnetic matrix, the aerosol is mixed homogeneously with the gas mixture, the aerosol-gas mixture is fed to a burner of known design and reacted in a flame within a combustion chamber, then the hot gases and the solids are cooled, then the gases are removed from the solids and the product is optionally purified by a thermal treatment by means of gases moistened with steam, the aerosol comprising the metal component of the superparamagnetic metal oxide and being prepared by nebulization, and chloride-containing compounds being used as the precursor of the matrix and/or as the aerosol.

The nebulization can preferably be effected by means of a one- or two-substance nozzle or by means of an aerosol generator.

The reactants, precursors of the metal oxide or metalloid oxide matrix and of the superparamagnetic domains, may, in both processes usable in accordance with the invention, for example, both be inorganic chlorine-containing salts. It is also possible for only the precursor of the metal oxide or metalloid oxide matrix to be chlorine-containing, and for the precursor of the superparamagnetic domains to be a chlorine-free inorganic salt, for example a nitrate, or a chlorine-free organometallic compound, for example iron pentacarbonyl. It is also possible that the precursor of the metal oxide or metalloid oxide matrix is a chlorine-free inorganic salt, for example nitrate, or a chlorine-free organometallic compound, for example a siloxane, and the precursor of the superparamagnetic domains is a chlorine-containing inorganic salt. It is particularly preferred that both the precursor of the metal oxide or metalloid oxide matrix and the precursor of the superparamagnetic domains are chlorine-containing inorganic salts.

In both processes, the cooling can preferably be effected by means of a heat exchanger or by directly mixing in water or a gas, for example air or nitrogen, or by adiabatic decompression of the process gas through a Laval nozzle.

The surface modifiers used may be the following substances: octyltrimethoxysilane, octyltriethoxysilane, hexamethyldisilazane, 3-methacryloyloxypropyltrimethoxysilane, 3-methacryloyloxypropyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane.

More preferably, octyltrimethoxysilane, octyltriethoxysilane and dimethylpolysiloxanes can be used.

The inventive surface-modified superparamagnetic particles exhibit good incorporation into alcohol, which extends the spectrum of use in adhesives.

In addition, the tendency to absorb water is significantly reduced, as a result of which the inventive product is significantly more storage-stable and possesses a higher heating capacity.

This is because a greater tendency to absorb water would reduce the heating capacity.

Owing to the higher heating capacity, the inventive product can be used in inductive adhesive systems in the low-frequency tension range.

The inventive surface-modified superparamagnetic oxidic particles can be used as fillers in adhesives. Further fields of use are use for data carriers, as a contrast agent in imaging processes, for biochemical separation and analysis processes, for medical applications, as an abrasive, as a catalyst or as a catalyst support, as a thickener, for thermal insulation, as a dispersing aid, as a flow aid and in ferrofluids.

### EXAMPLES

The reactant used is a superparamagnetic silicon dioxide according to EP 1 284 485. It has the physicochemical data listed in Table 1.

The reactant is initially charged in a mixer and sprayed while being mixed intensively optionally first with water and then with the surface modifier.

Once the spraying has ended, mixing can be continued for another 15 to 30 minutes, followed by heat treatment at 50 to 400° C. for 1 to 6 h.

The water used can be acidified with an acid, for example hydrochloric acid, down to a pH of 7 to 1. The silanizing agent used may be dissolved in a solvent, for example ethanol.

The further details are listed in Tables 2 and 3.

TABLE 1

| | Unit | Result |
|---|---|---|
| SiO₂ content, gravimetric | % | 48.1 |
| Saturation magnetization | Am2/kg | 29.7 |
| Zeta potential | | yes |
| BET surface area | m²/g | 43 |
| pH, 4% in water | | 3.0 |
| Grit > 45 μm (dis) | % | 4.0 |
| Grit > 45 μm (UT) | % | 0.14 |
| Grit > 45 μm (US) | % | 0.09 |
| d50, PCS, dissolver | nm | 215 |
| d50, PCS, Ultra-Turrax | nm | 147 |
| d50, PCS, ultrasound | nm | 135 |
| Ignition loss | % | 0.3 |
| Isoelectric point at pH | | 4.3, 3 |
| SiO₂ content, RFA | % | 59.5 |
| Fe, ICP | % | 51.5 |
| CI, RFA | ppm | 3040 |
| Fe, RFA | % | 40.02 |
| RFA | | RFA PH1399 |
| Phase analysis | | XRD PH1399 |
| Tamped density | g/l | 160 |
| Crystal size, XRD | nm | 23.8 |

TABLE 2
Preparation of the surface-modified oxides

| | | | Parts | | |
|---|---|---|---|---|---|
| | | | of | | |
| | | Parts | H₂O/100 | Heat | Heat |
| | | of SM*/100 | parts | treatment | treatment |
| | | parts of | of | temperature | time |
| Example | Surface modifier | oxide | oxide | [° C.] | [h] |
| 1 | octyltrimethoxysilane | 10 | — | 120 | 2 |
| 2 | octyltrimethoxysilane | 5 | 0.5 | 120 | 2 |
| 3 | octyltrimethoxysilane | 15 | — | 120 | 2 |
| 4 | octyltrimethoxysilane | 10 | 0.5 | 150 | 3 |

*SM = surface modifier

TABLE 3
Physicochemical data of the surface-modified
oxides

| | Spec. | | | | | |
|---|---|---|---|---|---|---|
| | BEt | | | | | |
| | surface | | Carbon | Tamped | Drying | |
| | area | | content | density | loss | |
| Example | [m²/g] | pH | [%] | [g/l] | [%] | Ignition loss [%] |
| 1 | 31 | 3.5 | 4.1 | 310 | 0.2 | 4.3 |
| 2 | 38 | 3.5 | 2.1 | 267 | 0.2 | 2.3 |
| 3 | 26 | 3.5 | 5.9 | 340 | 0.2 | 6.6 |
| 4 | 72 | 3.8 | 0.6 | 253 | 0.2 | 4.7 |

### Example 2a

### Preparation of a Dispersion

20.0 g of the powder from Example 1 are added to 108 g of distilled water. Subsequently, a sufficient amount of 1M NaOH is added until the pH is between 9.1 and 9.2. By means of a dissolver, the mixture is dispersed at 2000 rpm for 5 min. The pH of the dispersion is 9.1. The content of inventive powder is 15% by weight, the mean particle diameter d₅₀ being 190 nm.

### Example 2b

### Preparation of a Dispersion

30.0 g of the powder from Example 1 are added to 108 g of distilled water. Subsequently, a sufficient amount of 1M NaOH is added until the pH is between 9.1 and 9.2. By means of a dissolver, the mixture is dispersed at 10 000 rpm for 5 min. The pH of the dispersion is 9.1. The content of inventive powder is 20% by weight, the mean particle diameter d₅₀ being 140 nm.

### Example 2c

### Preparation of a Dispersion

35.0 g of the powder from Example 1 are added to 108 g of ethanol. Subsequently, sufficient ethanolic KOH is added until the pH is between 9.1 and 9.2. Subsequently, the dispersing assistant Disperbyk 190, in a ratio of 10% based on the reactant, is added. By means of an ultrasound finger, dispersion is effected at 100% power for 8 min. The pH of the dispersion is 9.1. The content of inventive powder is 21% by weight, the mean particle diameter d₅₀ being 99 nm.

### Example 3

### Adhesive Compositions

25 g of the powder from Example 1 are suspended in 100 ml of ethanol and 20 g of oxy-bis(benzo-sulphohydrazide) are added as a blowing agent. The mixture is heated to 60° C. with stirring for 5 hours. Subsequently, the solvent is drawn off by means of a rotary evaporator. The dry product is ground in a ball mill for 3 minutes and then screened. The fraction with a particle size of nominally less than 63 μm is used for the further experiments.

10 g of this powder are mixed with 300 g of the moisture-curing one-component polyurethane adhesive Dinitrol PUR 501 FC (Dinol GmbH) in the Planimax mixer (Molteni) provided with kneading hooks. The mixture is kneaded at level 1 (150 rpm) for 15 minutes.

1. Surface-modified superparamagnetic oxidic particles, characterized in that they have the following physicochemical characteristics:

| | |
|---|---|
| BET surface area | 20 to 75 m²/g |
| Carbon content | 0.5 to 6.0% by weight |
| Tamped density | 150 to 500 g/l |
| Chlorine content | 50 to 1000 ppm |
| Drying loss | 0.1 to 4.0% by weight. |

2. Process for preparing the surface-modified superparamagnetic oxidic particles according to claim 1, characterized in that the oxidic particles are optionally first sprayed with water and then with the surface modifier at room temperature, optionally mixed for 15 to 30 minutes and finally heat-treated at 50 to 400° C. for 1 to 6 h.

3. Process for preparing the surface-modified superparamagnetic oxidic particles according to claim 1, characterized in that the oxidic particles are treated with the surface modifier in vapour form and the mixture is subsequently treated thermally at a temperature of 50 to 800° C. over a period of 0.5 to 6 h.

4. The use of the surface-modified oxidic particles according to claim 1 as a filler in adhesives.
